(19) United States
(12) Patent Application Publication
(10) Pub. No.: US 2010/0128065 A1
(43) Pub. Date: May 27, 2010

(54) DRIVING METHOD AND DISPLAY UTILIZING THE SAME

(75) Inventors: Da-Wei LEE, Longtan Township (TW); Chih Jen Chen, Yongkang City (TW); Chieh-Yi Huang, Cyonglin Township (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/395,531

(22) Filed: Feb. 27, 2009

(30) Foreign Application Priority Data
Nov. 26, 2008 (TW) 097145667

(51) Int. Cl. G09G 5/10; G09G 3/36

(52) U.S. Cl. 345/690; 345/88

(57) ABSTRACT

A display including a scan driver, a data driver, a first pixel, and a second pixel is disclosed. The scan driver provides a first scan signal and a second scan signal. The data driver provides a data signal. The first pixel receives the first scan signal and displays a first color. The second pixel receives the second scan signal and displays a second color. The frequency of the first scan signal and the frequency of the second scan signal relate to the first color and the second color.

### CROSS REFERENCE TO RELATED APPLICATIONS

This Application claims priority of Taiwan Patent Application No. 97145667, filed on Nov. 26, 2008, the entirety of which is incorporated by reference herein.

### BACKGROUND OF THE INVENTION

1. Field of the Invention

The present invention relates to a driving method and a display.

2. Description of the Related Art

Because cathode ray tubes (CRTs) are inexpensive and provide high definition, they are utilized extensively in televisions and computers. With technological development, new flat-panel displays are continually being developed. When a larger display panel is required, the weight of the flat-panel display does not substantially change when compared to CRT displays.

### BRIEF SUMMARY OF THE INVENTION

Displays are provided. An exemplary embodiment of a display comprises a scan driver, a data driver, a first pixel, and a second pixel. The scan driver provides a first scan signal and a second scan signal. The data driver provides a data signal. The first pixel receives the first scan signal and displays a first color. The second pixel receives the second scan signal and displays a second color. The frequency of the first scan signal and the frequency of the second scan signal relate to the first color and the second color.

A driving method for a display is provided. An exemplary embodiment of a driving method for a display comprising a scan driver, a data driver, a first pixel displaying a first color, and a second pixel displaying a second color is described in the following. The scan driver is activated to provide a first scan signal to the first pixel. The scan driver is activated to provide a second scan signal to the second pixel. The frequency of the first scan signal and the frequency of the second scan signal relate to the first color and the second color.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic diagram of an embodiment of a display;

FIG. 1B is a structure diagram of an embodiment of the display;

FIG. 2 is a timing chart of scan signals;

FIG. 3 is a timing chart of another embodiment of scan signals

FIG. 4A is a schematic diagram of another embodiment of the display;

FIGS. 4B-4D are structure diagrams of other embodiments of the display;

FIG. 5 is a timing chart of an embodiment of scan signals shown in FIG. 4A; and

FIG. 6 is a flowchart of an embodiment of a driving method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

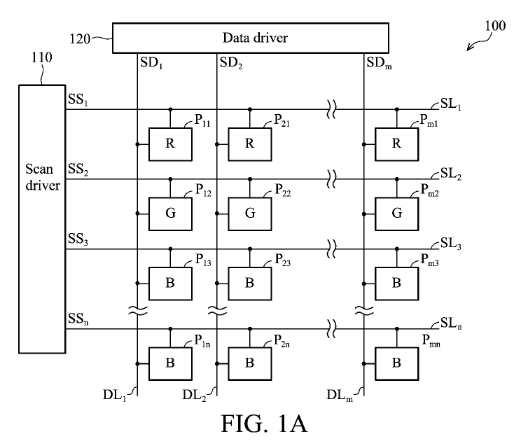

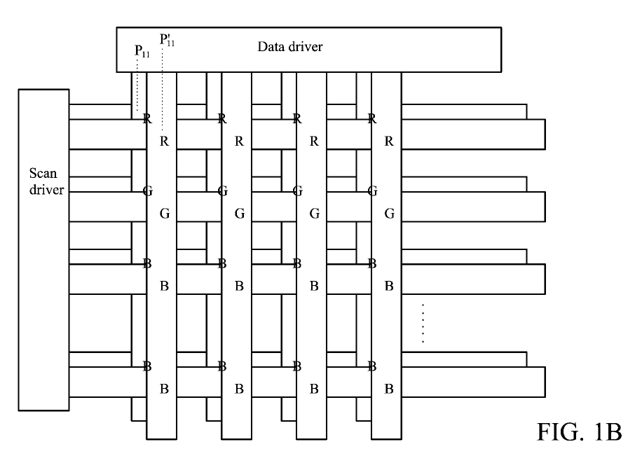

FIG. 1A is a schematic diagram of an embodiment of a display. The display 100 comprises a scan driver 110, a data driver 120, and pixels P₁₁˜Pₘₙ. In this embodiment, the pixels P₁₁˜Pₘₙ are not stacked together. The display 100 may be a cholesteric liquid crystal display (ChLCD), an electrophoresis display (EPD), an electro chromic display (ECD), or a twisting ball display (TBD).

The scan driver 110 provides scan signals SS₁˜SSₙ to the pixels P₁₁˜Pₘₙ via scan lines SL₁˜SLₙ. The frequencies of scan signals SS₁˜SSₙ relate to the color displayed by the pixels P₁₁˜Pₘₙ. Assume the color displayed by a first pixel among is the pixels P₁₁˜Pₘₙ is different from the color displayed by a second pixel among the pixels P₁₁˜Pₘₙ, then in this embodiment, the frequency of a first scan signal received by the first pixel is different from the frequency of a second scan signal received by the second pixel.

For example, if the color (such as red) displayed by the pixels P₁₁, P₂₁, . . . , and Pₘ₁ is different from the color (such as green) displayed by the pixels P₁₂, P₂₂, . . . , and Pₘ₂, the frequency of the scan signal SS₁ is different from the frequency of the scan signal SS₂. Similarly, if the color (such as red) displayed by the pixels P₁₁, P₂₁, . . . , and Pₘ₁ is different from the color (such as blue) displayed by the pixels P₁₃, P₂₃, . . . , and Pₘ₃, the frequency of the scan signal SS₁ is different from the frequency of the scan signal SS₃.

In another embodiment, the frequency of a first scan signal among the scan signals SS₁˜SSₙ is the same as the frequency of a second scan signal among the scan signals SS₁˜SSₙ when the color displayed by a first pixel among the pixels P₁₁˜Pₘₙ is the same as the color displayed by a second pixel among the pixels P₁₁˜Pₘₙ. In this case, the first pixel receives the first scan signal and the second pixel receives the second scan signal. For example, the pixels P₁₃, P₂₃, . . . , Pₘ₃, P₁ₙ, P₂ₙ, . . . , and Pₘₙ display the same color, such as blue. Thus, the frequency of the scan signal SS₃ is the same as the frequency of the scan signal SSₙ.

The data driver 120 provides data signals SD₁˜SDₘ to the pixels P₁₁˜Pₘₙ via data lines DL₁˜DLₘ. The brightness or gray levels of the pixels P₁₁˜Pₘₙ relates to the duration of data signals SD₁˜SDₘₙ. Taking the pixel P₁₁ as an example, when the duration of the data signal SD₁ provided by the data driver 120 becomes longer, the brightness of the pixel P₁₁ becomes brighter. Similarly, when the duration of the data signal SD₁ provided by the data driver 120 becomes shorter, the brightness of the pixel P₁₁ becomes darker. Thus, the brightness of the pixels P₁₁˜Pₘₙ can be controlled according to the duration of the data signals SD₁˜SDₘₙ.

FIG. 1B is a structure diagram of an embodiment of the display. The display comprises two panels stacked together. Each panel comprises a plurality of pixels. The pixels in one panel are stacked with the pixels in another panel. Taking a ChLCD as an example, each pixel may comprise a levorotary cholesteric liquid component or a dextrorotatory cholesteric liquid component to increase reflectivity. For example, the pixel P₁₁ comprises the levorotary cholesteric liquid component and the pixel P′₁₁ comprises the dextrorotatory cholesteric liquid component. In this embodiment, when the color of a first pixel is different from the color of a second pixel, the frequency of a first scan signal is different from the frequency of a second scan signal, wherein he first scan signal is provided to the first pixel and the second scan signal is provided to the second pixel.

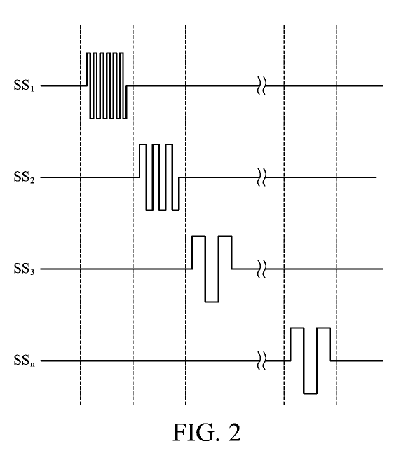

FIG. 2 is a timing chart of scan signals. For clarity, only four scan signals SS₁, SS₂, SS₃, and SSₙ are shown. Referring to FIG. 1A, since the pixels P₁₁, P₁₂, and P₁₃ display the different colors, the frequencies of scan signals SS₁, SS₂, and SS₃ are different. In this embodiment, the frequency of the scan signal SS₁ is higher than the frequencies of scan signals SS₂, and SS₃. The frequency of the scan signal SS₂ is higher than the frequency of the scan signal SS₃. In some embodiments, the frequency of the scan signal SS₁ may be less than the frequency of the scan signal SS₂ or the frequency of the scan signal SS₃.

Since the color displayed by the pixel P₁₃ is the same as the color displayed by the pixel P₁ₙ, the frequency of the scan signal SS₃ is the same as the frequency of the scan signal SSₙ. In this embodiment, the amplitudes of the scan signals SS₁, SS₂, SS₃, and SSₙ are the same, but the disclosure is not limited thereto. The amplitudes of the scan signals SS₁, SS₂, SS₃, and SSₙ can be changed according to the kind of the display. For example, if the display is a ChLCD, each pixel comprises cholesteric liquid crystal molecules. The arrangement of cholesteric liquid crystal molecules is determined by the voltage difference between a scan signal and a data signal.

In one embodiment, the frequency of the data signal SD₁ received by the pixel P₁₁ is the same as or different from the frequency of the scan signal SS₁. In some embodiments, a phase difference arises between the data signal SD₁ and the scan signal SS₁. The phase difference may be 180°.

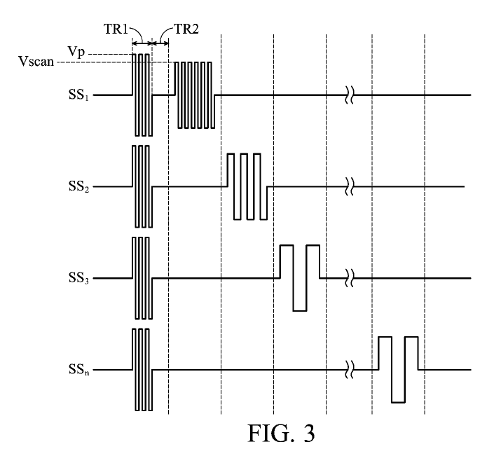

FIG. 3 is a timing chart of another embodiment of scan signals FIG. 3 is similar to FIG. 2 except for the addition of a reset period. The reset period is composed of periods TR1 and TR2.

During the period TR1, the scan signals SS₁, SS₂, SS₃, and SSₙ with amplitude Vp are provided to the pixels. During the period TR2, the scan signals SS₁, SS₂, SS₃, and SSₙ with amplitude 0V are provided to the pixels P₁₁˜Pₘₙ. Thus, the arrangement of the pixels is a planar type. For example, the arrangement of the pixels may be changed from a focal conic type to the planar type or may be maintained in the planar type. At this time, the pixels P₁₁˜Pₘₙ are lighted. In this embodiment, the amplitude Vscan of the scan signal after the period TR2 is less than the amplitude Vp of the scan during the period TR1.

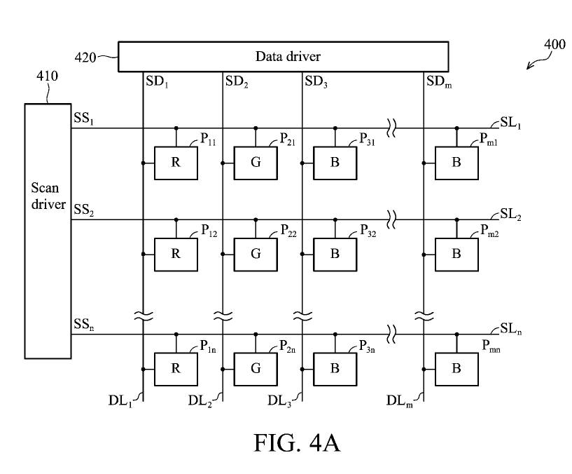

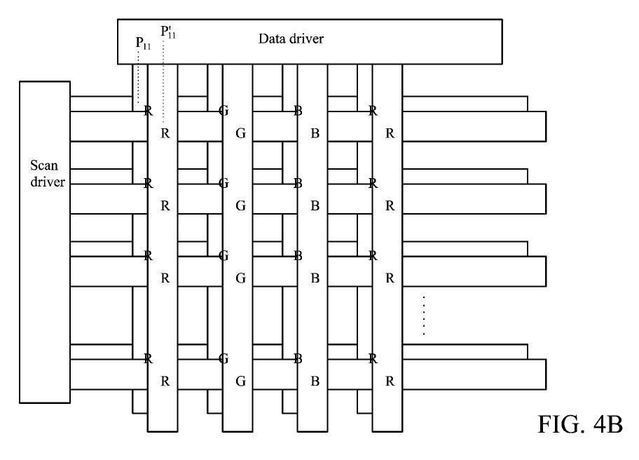

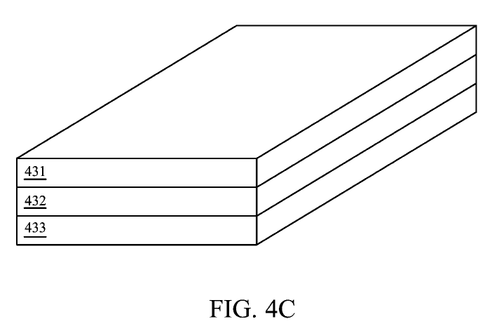

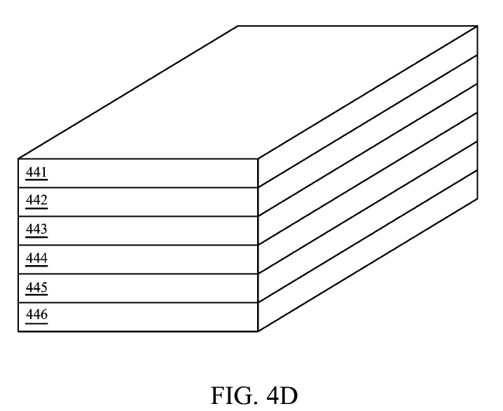

FIG. 4A is a schematic diagram of another embodiment of the display. FIG. 4A is similar to FIG. 1 with the exception of the arrangement of the pixels P₁₁˜Pₘₙ. As shown in FIG. 4A, the pixels displaying the same color are coupled to the different scan lines. For example, the pixels P₁₁, P₁₂, . . . , and P₁ₙ display red and are coupled to the scan lines SL₁, SL₂, . . . , and SLₙ respectively.

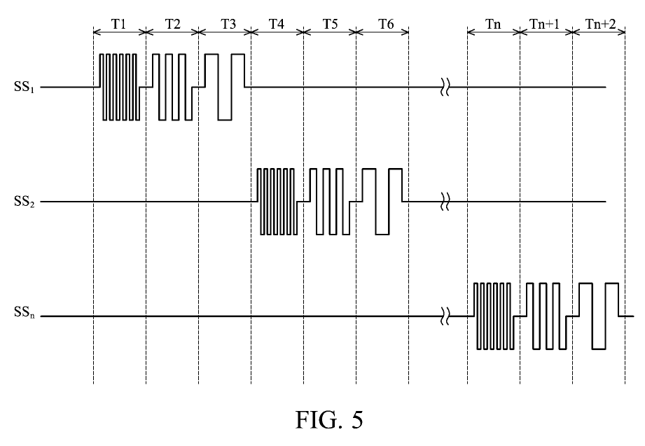

FIG. 5 is a timing chart of an embodiment of scan signals shown in FIG. 4A. For clarity, only three scan signals SS₁, SS₂, and SSₙ are shown. During a period T1, the scan signal SS₁ comprises a first frequency. At this time, the frequency and the amplitude of the data signals are controlled such that a portion of the pixels coupled to the scan line SL₁ display the same color. In one embodiment, the pixels comprising the pixel P₁₁ and coupled to the scan line SL₁ display red according to the voltage difference between the scan signal SS₁ and the data signal.

During a period T2, the scan signal SS₁ comprises a second frequency. At this time, the frequency and the amplitude of the data signals are controlled such that another portion of the pixels coupled to the scan line SL₁ display the same color. In one embodiment, the pixels comprising the pixel P₂₁ and coupled to the scan line SL₁ display green according to the voltage difference between the scan signal SS₁ and the data signal.

During a period T3, the scan signal SS₁ comprises a third frequency. At this time, the frequency and the amplitude of the data signals are controlled such that the other portion of the pixels coupled to the scan line SL₁ display the same color. In one embodiment, the pixels comprising the pixels P₃₁ and Pₘ₁ and coupled to the scan line SL₁ display blue according to the voltage difference between the scan signal SS₁ and the data signal.

During a period T4, the scan signal SS₂ comprises a first frequency. At this time, the frequency and the amplitude of the data signals are controlled such that a portion of the pixels coupled to the scan line SL₂ display the same color. In this embodiment, the frequency of the scan signal SS₂ during the period T4 is the same as the frequency of the scan signal SS₁ during the period T1. Thus, the pixels comprising the pixel P₁₂ and coupled to the scan line SL₂ display red according to the voltage difference between the scan signal SS₂ and the data signal.

During a period T5, the scan signal SS₂ comprises a second frequency. At this time, the frequency and the amplitude of the data signals are controlled such that another portion of the pixels coupled to the scan line SL₂ display the same color. In this embodiment, the frequency of the scan signal SS₂ during the period T5 is the same as the frequency of the scan signal SS₁ during the period T2. Thus, the pixels comprising the pixel P₂₂ and coupled to the scan line SL₂ display green according to the voltage difference between the scan signal SS₂ and the data signal.

During a period T6, the scan signal SS₂ comprises a third frequency. At this time, the frequency and the amplitude of the data signals are controlled such that the other portion of the pixels coupled to the scan line SL₂ display the same color. In this embodiment, the frequency of the scan signal SS₂ during the period T6 is the same as the frequency of the scan signal SS₁ during the period T3. Thus, the pixels comprising the pixels P₃₂ and Pₘ₂ and coupled to the scan line SL₂ display blue according to the voltage difference between the scan signal SS₂ and the data signal.

During a period Tn, the scan signal SSₙ comprises a first frequency. In this embodiment, the frequency of the scan signal SSₙ during the period Tn is the same as the frequency of the scan signal SS₁ during the period T1. Thus, the pixels comprising the pixel P₁ₙ and coupled to the scan line SLₙ display red according to the voltage difference between the scan signal SSₙ and the data signal.

During a period Tn+1, the scan signal SSₙ comprises a second frequency. In this embodiment, the frequency of the scan signal SSₙ during the period Tn+1 is the same as the frequency of the scan signal SS₁ during the period T2. Thus, the pixels comprising the pixel P₂ₙ and coupled to the scan line SLₙ display green according to the voltage difference between the scan signal SSₙ and the data signal.

During a period Tn+2, the scan signal SSₙ comprises a third frequency. In this embodiment, the frequency of the scan signal SSₙ during the period Tn+2 is the same as the frequency of the scan signal SS₁ during the period T3. Thus, the pixels comprising the pixels P₃ₙ and Pₘₙ and coupled to the scan line SLₙ display blue according to the voltage difference between the scan signal SSₙ and the data signal.

In some embodiments, the scan signals SS₁, SS₂, and SSₙ as shown in FIG. 5 also comprise the reset period as shown in FIG. 3. In addition, assuming the display is a ChLCD comprising a first pixel and a second pixel, then the color displayed by the first pixel will be different from the color displayed by the second pixel. If the frequency received by the first pixel is different from the frequency received by the second pixel, the R-V curve of the first pixel will approach the R-V curve of the second pixel, wherein R is a reflectivity of the cholesteric liquid component and V is a voltage difference between a scan signal and a data signal. Thus, the pixels displaying the different colors can be controlled by one voltage source.

FIG. 4B is a structure diagram of an embodiment of the display. The display comprises two panels stacked together. Each panel comprises a plurality of pixels. The pixels in one panel are stacked with the pixels in another panel. Taking a ChLCD as an example, each pixel comprises a levorotary cholesteric liquid component and a dextrorotatory cholesteric liquid component to increase reflectivity. For example, the pixel P₁₁ comprises the levorotary cholesteric liquid component and the pixel P′₁₁ comprises the dextrorotatory cholesteric liquid component. In this embodiment, when the color displayed by a first pixel is different from the color displayed by a second pixel, the frequency of a first scan signal received by the first pixel is different from the frequency of a second scan signal received by the second pixel.

FIG. 4C is a schematic diagram of another embodiment of a display. The display comprises three panels 431˜433 stacked together. Each of the panels 431˜433 comprises a plurality of pixels. The pixels in the same panel display the same color. The pixels in one panel are stacked with the pixels in another panel. Taking a ChLCD as an example, assuming that the color displayed by the panel 431 is red, the color displayed by the panel 432 is green, and the color displayed by the panel 433 is blue. In this embodiment, the frequencies of the scan signals received by the panels 431˜433 are different because the panels 431˜433 display the different colors.

FIG. 4D is a schematic diagram of another embodiment of a display. The display comprises six panels 441˜446 stacked together. Each of the panels 441˜446 comprises a plurality of pixels. The pixels in the same panel are capable of displaying a specific color and arranged into a specific rotational direction. The pixels in one panel are stacked with the pixels in another panel. The pixels in the different panels are capable of displaying the different colors and arranged into the different rotational directions. For example, the panel 441 comprises the levorotary cholesteric liquid component and displays red. The panel 442 comprises the dextrorotatory cholesteric liquid component and displays red. The panel 443 comprises the levorotary cholesteric liquid component and displays green. The panel 444 comprises the dextrorotatory cholesteric liquid component and displays green. The panel 445 comprises the levorotary cholesteric liquid component and displays blue. The panel 446 comprises the dextrorotatory cholesteric liquid component and displays blue. The reflectivity of the pixels can be increased by the levorotary cholesteric liquid components and the dextrorotatory cholesteric liquid components.

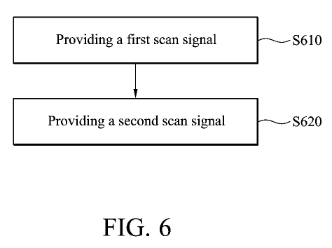

FIG. 6 is a flowchart of an embodiment of a driving method. The driving method can be applied in a display. The display comprises a scan driver, a data driver, a first pixel, and a second pixel. The first pixel displays a first color. The second pixel displays a second color.

First, the scan driver is activated to provide a first scan signal to the first pixel (step S610). Then, the scan driver is activated to provide a second scan signal to the second pixel (step S620). The frequency of the first scan signal and the frequency of the second scan signal relate to the first color and the second color. In one embodiment, if the first color is different from the second color, the frequency of the first scan signal is different from the frequency of the second scan signal. In another embodiment, if the first color is the same as the second color, the frequency of the first scan signal is the same as the frequency of the second scan signal.

Furthermore, the first and the second pixels receive the first and the second scan signals via the same scan line. In other embodiment, the first pixel receives the first scan signal via a first scan line and the second pixel receives the second scan signal via a second scan line different from the first scan line. Additionally, the first pixel is stacked or not stacked with the second pixel.

In one embodiment, the first pixel displays color according to the voltage difference between the first scan signal and a data signal. In this case, the brightness of the first pixel is determined by the duration of the data signal provided by the data driver. In another embodiment, the frequency of the data signal is equal to or not equal to the frequency of the first scan signal. Furthermore, the amplitude of the first scan signal is the same as or different from the amplitude of the second scan signal.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display, comprising
a scan driver providing a first scan signal and a second scan signal;
a data driver providing a data signal;
a first pixel receiving the first scan signal and displaying a first color; and
a second pixel receiving the second scan signal and displaying a second color, wherein the frequency of the first scan signal and the frequency of the second scan signal relate to the first color and the second color.

2. The display as claimed in claim 1, wherein when the first color is different from the second color, the frequency of the first scan signal is different from the frequency of the second scan signal.

3. The display as claimed in claim 1, wherein when the first color is the same as the second color, the frequency of the first scan signal is the same as the frequency of the second scan signal.

4. The display as claimed in claim 1, wherein the first pixel receives the first scan signal via a scan line and the second pixel receives the second scan signal via the scan line.

5. The display as claimed in claim 4, wherein the first pixel is not stacked with the second pixel.

6. The display as claimed in claim 4, wherein the first pixel is stacked with the second pixel.

7. The display as claimed in claim 1, wherein the first pixel receives the first scan signal via a first scan line and the second pixel receives the second scan signal via a second scan line different from the first scan line.

8. The display as claimed in claim 7, wherein the first pixel is not stacked with the second pixel.

9. The display as claimed in claim 7, wherein the first pixel is stacked with the second pixel.

10. The display as claimed in claim 1, wherein the amplitude of the first scan signal is the same as the amplitude of the second scan signal.

11. The display as claimed in claim 1, wherein the brightness of the first pixel relates to the duration of the data signal providing by the data driver.

12. The display as claimed in claim 1, wherein the frequency of the data signal is equal to or not equal to the frequency of the first scan signal.

13. The display as claimed in claim 1, wherein the display is a cholesteric liquid crystal display (ChLCD).

14. A driving method for a display comprising a scan driver, a data driver, a first pixel displaying a first color, and a second pixel displaying a second color, comprising:
activating the scan driver to provide a first scan signal to the first pixel; and
activating the scan driver to provide a second scan signal to the second pixel, wherein the frequency of the first scan signal and the frequency of the second scan signal relate to the first color and the second color.

15. The driving method as claimed in claim 14, wherein when the first color is different from the second color, the frequency of the first scan signal is different from the frequency of the second scan signal.

16. The driving method as claimed in claim 14, wherein when the first color is the same as the second color, the frequency of the first scan signal is the same as the frequency of the second scan signal.

17. The driving method as claimed in claim 14, wherein the first pixel receives the first scan signal via a scan line and the second pixel receives the second scan signal via the scan line.

18. The driving method as claimed in claim 17, wherein the first pixel is not stacked with the second pixel.

19. The driving method as claimed in claim 17, wherein the first pixel is stacked with the second pixel.

20. The driving method as claimed in claim 14, wherein the first pixel receives the first scan signal via a first scan line and the second pixel receives the second scan signal via a second scan line different from the first scan line.

21. The driving method as claimed in claim 20, wherein the first pixel is not stacked with the second pixel.

22. The driving method as claimed in claim 20, wherein the first pixel is stacked with the second pixel.

23. The driving method as claimed in claim 14, wherein the amplitude of the first scan signal is the same as the amplitude of the second scan signal.

24. The driving method as claimed in claim 14, wherein the brightness of the first pixel relates to the duration of the data signal providing by the data driver.

25. The driving method as claimed in claim 14, further comprising:
activating the data driver to provide a data signal, wherein the frequency of the data signal is equal to or not equal to the frequency of the first scan signal.
